(19) United States
(12) Patent Application Publication
(10) Pub. No.: US 2017/0174309 A1
(43) Pub. Date: Jun. 22, 2017

(54) AIRCRAFT ACCESS DOOR AND AIRCRAFT

(71) Applicant: EMBRAER S.A., Sao Jose dos Campos - SP (BR)

(72) Inventors: Emmanuel Basile GARAKIS, Sao Jose dos Campos - SP (BR); Douglas Gonçalves DE ALBUQUERQUE, Sao Jose dos Campos - SP (BR); Ricardo Athayde ABELHEIRA, Sao Jose dos Campos - SP (BR); Silvio Hideo Lemos MOCHIDUKY, Sao Jose dos Campos - SP (BR); André GASPAROTTI, Sao Jose dos Campos - SP (BR); Demétrio Andrade DE CAMPOS, Sao Jose dos Campos - SP (BR); Carlos Rosley BERNARDES, Sao Jose dos Campos - SP (BR); Mateus Rodrigues MIRANDA, Sao Jose dos Campos - SP (BR); Carlos Marcelo Campos TEIXEIRA, Sao Jose dos Campos - SP (BR); Walter AFFONSO, JR., Sao Jose dos Campos - SP (BR); Fernanda Loth PUGLIESI, Sao Jose dos Campos - SP (BR); Bruno Kimura CASTANHA, Sao Jose dos Campos ? SP (BR); Mauri Mendes DE OLIVEIRA, Sao Jose dos Campos - SP (BR); Sérgio Raphael Fonseca AFFONSO, Sao Jose dos Campos - SP (BR)

(21) Appl. No.: 15/379,948

(22) Filed: Dec. 15, 2016

(30) Foreign Application Priority Data
Dec. 17, 2015 (BR) 102015031730-1

(51) Int. Cl. B64C 1/14; B64C 1/24

(52) U.S. Cl. CPC B64C 1/1423; B64C 1/1461; B64C 1/24

(57) ABSTRACT

It describes an aircraft access door, in particular a boarding and landing access door arranged centrally on a fuselage portion of the aircraft and perpendicularly relative to a longitudinal axis of the aircraft, the access door being formed by a wing fairing disposed adjacent to a fuselage floor and a fuselage fairing associated with the wing fairing, the wing fairing being provided with rotational means positioned below the floor, the fuselage fairing being provided of access means interconnecting the floor to the ground.

It further describes an aircraft provided with an access door, particularly a boarding and landing access door, arranged centrally on a fuselage portion of the aircraft and perpendicularly to a longitudinal axis of the aircraft.

The instant invention relates to an aircraft access door, in particular to a boarding and landing access door arranged centrally relative to the longitudinal axis of the aircraft and incorporating the fairing wing fuselage, facilitating the flow and access of passengers to the interior areas of the cabin. This invention further relates to an aircraft having this aircraft access door.

### Prior Art Description

Executive aircraft usually comprise access doors on the front of the fuselage. Although many models of executive aircraft have built-in stairs to these doors, there is always a great difficulty for passengers to access it and the need to operate the door in order to open it, due to the height of the aircraft floor to the ground.

Furthermore, in these aircrafts the cabin area in front of the access door is of little use. This is because it is an area usually limited by the panel separating the cockpit from the rest of the cabin and by bulkheads and/or cabinets delimiting and segregating that area from the rest of the cabin.

Another drawback observed in the frontal positioning of the access door in already-known executive aircraft is the noise produced in front of the door. This noise comes from the formation of vortex at the junction of that door with the fuselage and causes discomfort to the passenger sitting or using the area near the access door.

As an aircraft gains speed, the boundary layer that begins at the front of the aircraft progressively increases until the end of it. Thereby, if the access door is in the front of the fuselage, it will suffer with the noise because the boundary layer in this region is thin. Moreover, the positioning of the access door on the front of the aircraft, especially on executive aircraft, makes the existence of private areas impossible or imposes the need to create such private areas in the rear of the aircraft, as occupants have access through the front portion and need to move through the various areas along the internal extent of that aircraft until they reach their seats or the desired area. In executive aviation, in which aircraft are developed with a high degree of customization, the lack of privacy causes great discomfort and has been one of the biggest problems to be solved in this market.

In this regard, the central door positioning in commercial aircraft is described in document N°. U.S. Pat. No. 4,176,812, particularly applied to aircrafts in which the wings and fuselage are homogeneous, that is, joined together forming a smooth curve on the outside of the aircraft. In this case, the central door is intended to facilitate the aircraft evacuation procedure in cases of emergency, meeting the evacuation rate specifications imposed by the aviation authorities. To this end, the central door is provided with stairs that allows passengers to leave the cabin to the surface of the wing that is above the floor level of the cabin. Thus, although the positioning of a door in the central region of the fuselage of an aircraft has already been described, this central door does not solve the problems encountered in the executive aircraft and described above.

### Objectives of the Invention

Thus, the objective of the instant invention is that of providing a boarding and landing access door arranged centrally relative to the longitudinal axis of the aircraft and incorporating the fairing wing fuselage, facilitating the flow and access of passengers to the interior areas of the cabin.

This invention further aims to provide an aircraft having a boarding and landing aircraft access door arranged centrally relative to the longitudinal axis of the aircraft and which incorporates the fairing wing fuselage.

### BRIEF DESCRIPTION OF THE INVENTION

The objective of the instant invention is an aircraft access door, arranged centrally relative to a longitudinal axis of the aircraft, the access door being formed by a wing fairing disposed adjacent to a fuselage floor and a fuselage fairing associated with the wing fairing, the wing fairing being provided with rotational means positioned below the floor and the fuselage fairing being provided Of access means interconnecting the floor to the ground.

An objective of this invention is further an aircraft provided with an access door, arranged centrally relative to a longitudinal axis of the aircraft, the access door being formed by a wing fairing disposed adjacent to a fuselage floor and a fuselage fairing associated with the wing fairing, the wing fairing being provided with rotational means positioned below the floor and the fuselage fairing being provided Of access means interconnecting the floor to the ground.

### BRIEF DESCRIPTION OF THE DRAWINGS

It follows a more detailed description of the instant invention, based on one embodiment represented in the drawings. The figures show:

FIG. 1—is a schematic view of the boarding and landing access door of the aircraft subject matter of this invention, when it is open.

FIG. 2—is a schematic view of the boarding and landing access door of the aircraft subject matter of this invention, when it is closed.

FIG. 3—is a schematic view of the boarding and landing access door of the aircraft subject matter of this invention in its opening process; and

FIG. 4—is a schematic cross-sectional view of the fuselage of an aircraft illustrating the means for rotating the access door.

### DETAILED DESCRIPTION OF THE INVENTION

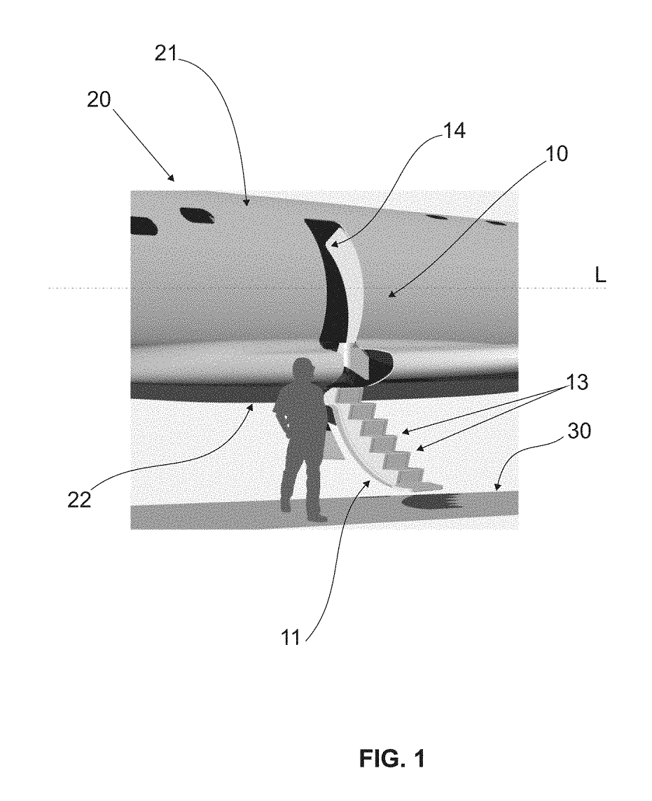

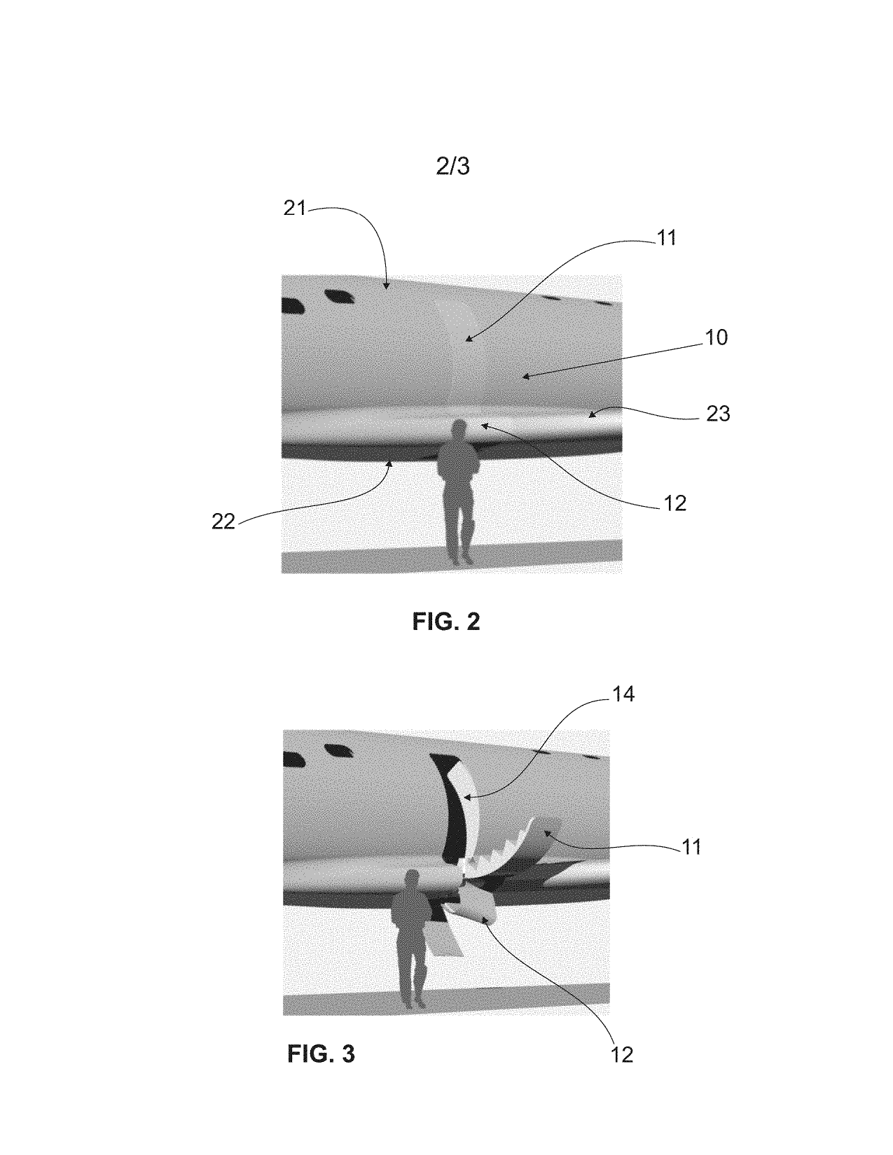

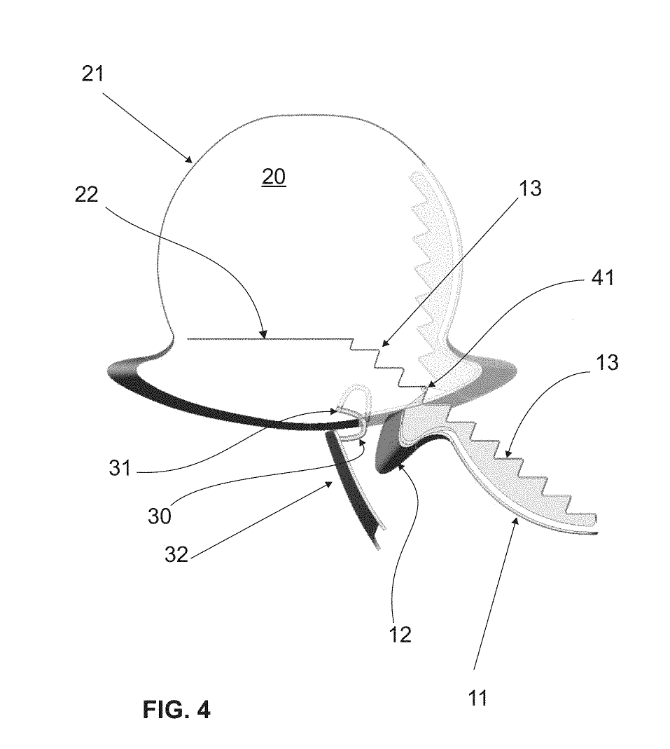

According to a preferred embodiment and as it can be seen from FIG. 1, the instant invention relates to an access door 10 for aircraft 20, particularly a boarding and landing access door arranged centrally in a fuselage portion 21 Of this aircraft 20 and perpendicular to the longitudinal axis L of the aircraft 20.

This access door 10 is formed by a wing fairing 12 associated with a fuselage fairing 11. The wing fairing 12 is arranged adjacent to the floor 22 of the fuselage 20, more precisely the floor 22 of the cabin internal to the fuselage 20, and is provided with rotating means. The rotating means consist of a first arm 30 associated with a first shaft 31 and to a floor door 32, and a second shaft 41, the wing fairing 12 and, consequently, the fuselage fairing 11 being associated therewith.

The first arm 30, associated with the first shaft 41, having the function of opening and closing the floor door 32, by means of rotation about the first axis 31, thus providing space for the opening and closing of the access door 10.

Simultaneously with the opening of the floor door 32, the wing fairing 12 and the fuselage fairing 11 are rotated about the second shaft 41, which results in the opening of the access door 10.

In this regard, through the above-described rotating means the wing fairing 12 and the fuselage fairing 11 are simultaneously moved between an open position and a closed position. In the closed position, the wing fairing 12 and the fuselage fairing 11 are made up of a wing portion 23 and the fuselage 21 of the aircraft respectively, maintaining the aerodynamics of the aircraft 20. In the open position, the wing fairing 12 and the fuselage fairing 11 form a central opening 14 in the fuselage 20 and interconnect the floor 22 to the floor 30.

Because of the positioning of the rotational means moved down the floor 22, the size of the access door 10 and the size of the central opening 14 in the fuselage are larger than the commonly known doors and apertures, facilitating the opening of this access door 10, and it also facilitates boarding and landing of passengers or users.

For user or passenger access to the interior of the aircraft, the fuselage fairing 11 is provided with access means 13 consisting of steps, conveyor belt or other means enabling the user to walk on the fuselage fairing 11 and to access the inside of the aircraft. Moreover, the access means 13 interconnects the floor 22 to the floor 30 so as to enable the user to climb the fuselage fairing 11 from the floor 30 without the need for external elements such as stairs, chocks, supports, inter alia. Therefore, by the access door 10 in the open position it is possible to access the inside of the aircraft smoothly and without obstructions, since a final stretch of the access means 13 enters the cabin inside the aircraft 20. This means that the last step or the last stretch of the access means 13 is coincident with the floor 22 of the cabin, allowing a smooth transition from the external medium into the aircraft.

Moreover, with the centralized positioning of this access door 10, when the passenger or user boards, he can choose which area of the cabin he wants to access or is allowed to access. Thus, it is possible to create a private space in the cabin, for the user's restricted usage, and public spaces of general access, as due to the door centralized position it becomes possible to direct the passengers inside the cabin,

Wherein the centralized position of the access door 10 further brings the benefit of supplying the noises and the “dead” space that usually forms in front of the door, in addition to allow a complete use of the internal space of the cabin.

Moreover, the invention relates to an aircraft (20) comprising the above-described access door 10, arranged centrally on a fuselage portion 21 and perpendicularly in relation to the longitudinal axis L of the aircraft 20.

Due to the increase of the boundary layer in the central region of the fuselage, the noise from outside is sealed by the boundary layer.

Although only one preferred embodiment has been described, it must be understood that the scope of the instant invention covers other possible alternatives and that it is limited only by the content of the claims, the possible equivalents being included therein.

1. An aircraft access door, wherein it is arranged centrally on a fuselage portion of the aircraft and perpendicularly relative to a longitudinal axis of the aircraft, the access door being formed by a wing fairing disposed adjacent to a fuselage floor and a fuselage fairing associated with the wing fairing, the wing fairing being provided with rotational means positioned below the floor and the fuselage fairing being provided with access means interconnecting the floor to the ground.

2. The aircraft access door, according to claim 1, wherein the wing fairing and the fuselage fairing are simultaneously moved between an open position and a closed position.

3. The aircraft access door, according to claim 2, wherein the wing fairing and the fuselage fairing are moved through the rotational means.

4. The aircraft access door, according to claim 3, wherein in the closed position, the wing fairing and the fuselage fairing are composed of a wing portion and the fuselage of the aircraft maintaining the aerodynamics of the aircraft.

5. The aircraft access door, according to claim 3, wherein in the open position, the wing fairing and the fuselage fairing form a central opening in the fuselage and interconnect the floor to the ground.

6. The aircraft access door, according to claim 3, wherein the rotational means consist of a first arm associated with a first shaft and with a floor door, the first arm and the floor door being rotated about the first shaft.

7. The aircraft access door, according to claim 3, wherein the rotational means further comprise the wing fairing associated with a second shaft, wherein said wing fairing in combination with the fuselage fairing rotate around it, to open or close the access door.

8. Aircraft access door, according to claim 1, wherein the access means of the fuselage fairing consist of steps.

9. The aircraft, wherein comprising an access door arranged centrally on a fuselage portion of the aircraft and perpendicularly relative to a longitudinal axis of the aircraft, said access door being formed by a wing fairing disposed adjacent to a fuselage floor and a fuselage fairing associated with the wing fairing, the wing fairing (12) being provided with rotational means positioned below the floor, the fuselage fairing being provided Of access means interconnecting the floor to the ground.
